(19) United States
(12) Patent Application Publication
(10) Pub. No.: US 2003/0101423 A1
(43) Pub. Date: May 29, 2003

(54) Clock grid skew reduction using a wire tree architecture

(76) Inventors: Tyler Thorp, Sunnyvale, CA (US); Pradeep Trivedi, Sunnyvale, CA (US); Gin Yee, Sunnyvale, CA (US); Lynn Ooi, Santa Clara, CA (US)

Correspondence Address: ROSENTHAL & OSHA L.L.P., 1221 MCKINNEY AVENUE, SUITE 2800, HOUSTON, TX, 77010, US

(21) Appl. No.: 09/997,426

(22) Filed: Nov. 29, 2001

(51) Int. Cl. G06F 17/50

(52) U.S. Cl. 716/6; 716/1

(57) ABSTRACT

An integrated circuit having a clock driver connected to a non-peripheral region of a clock grid is provided. Providing interconnect that connect a clock driver to non-peripheral regions the clock grid effectively leads to reduced clock skew due to reduced RC delays from clock grid connection points to components operatively connected to the clock grid. Further, a method for reducing clock skew on a clock grid using a wire tree architecture structure is provided.

### BACKGROUND OF INVENTION

A typical computer system includes at least a microprocessor and some form of memory. The microprocessor has, among other components, arithmetic, logic, and control circuitry that interpret and execute instructions necessary for the operation and use of the computer system. FIG. 1 shows a typical computer system (10) having a microprocessor (12), memory (14), integrated circuits (16) that have various functionalities, and communication paths (18), i.e., buses and wires, that are necessary for the transfer of data among the aforementioned components of the computer system (10).

The components of a computer system use a reference of time to perform the various operations of the computer system. This reference of time is provided to the components of the computer system using one or more clock signals. The components use the one or more clock signals to determine when to conduct certain operations. As computer systems continue to operate at ever-increasing frequencies, it becomes more and more important to ensure that the components of a computer system receive their clock signals in an accurate and timely manner. A mistiming has the potential to cause an error, performance setback, or an outright malfunction of the computer system.

FIG. 2 shows a clock distribution network (20) for a microprocessor (12). A reference clock (also known in the art as “system clock” and shown in FIG. 2 as ref_clk), which is typically generated from outside the microprocessor (12), serves as an input to a phase locked loop (“PLL”) (15). Essentially, the PLL (15) uses feedback to maintain a specific phase relationship between its output (shown in FIG. 2 as chip_clk) and the reference signal. The chip clock from the PLL (15) is then distributed to one or more clock drivers/buffers (17), which, in turn, distribute the chip clock to a global clock grid (19). The global clock grid (19) feeds the chip clock to various microprocessor components such as local clock grids (24) and a feedback loop (26) that feeds the chip clock back to the PLL (14). The local clock grids (24) feed the chip clock to base components of the microprocessor (12), such as latches (22) and flip-flops (28).

As a clock signal, such as the chip clock shown in FIG. 2, is propagated to the various parts and components of a microprocessor, one or more types of system variations may alter the behavior and/or integrity of the clock signal. Common system variations include, but are not limited to, voltage variations, temperature variations, and process variations. Due to these and other variations across a microprocessor, a particular clock signal may arrive at different parts of the microprocessor at different times. This difference in the arrival of a clock signal at different system components is referred to and known in the art as “clock skew.”

The actual architectural implementation of a clock distribution network is another factor that affects clock skew. With the increasing die size and complexity of integrated circuit designs, it becomes necessary to have long metal wires, known as “interconnects,” to distribute a clock signal to the various parts of the integrated circuit. FIG. 3a shows a top view of a typical clock distribution network. In FIG. 3a, clock drivers (also referred to and known as “clock drivers”) (40) distribute clock signals onto a clock grid (42). The various components of an integrated circuit dependent on the clock signals provided by the clock drivers (40) are operatively connected to various points along the clock grid (42).

FIG. 3b shows a section of the clock distribution network shown in FIG. 3a. Particularly, FIG. 3b shows the implementation of interconnects (44) that connect the clock drivers (40) to the clock grid (42).

Technically, interconnects do not behave as virtual or ideal wires. Instead, interconnects behave more like a network of capacitors and resistors. Thus, in effect, interconnects are characterized by resistor-capacitor (“RC”) delays. Such RC delays, which are primarily a function of length, can dominate circuit behavior, especially with respect to circuit timing.

FIG. 3c shows an expanded view of the section of the typical clock distribution network shown in FIG. 3b. As discussed above with reference to FIG. 3b, a clock driver (40) is connected to the clock grid (42) via an interconnect (44). Two points, p1 and p2, are denoted on the clock grid (42) to represent points on the clock grid (42) where the time of arrival of a clock signal is at interest. Referring now also to the timing diagram shown in FIG. 3d, when a clock signal from a particular clock driver (40) is driven to the clock grid (42), the clock signal arrives at p1 some finite amount of time before it arrives at p2. This is due to the fact that the clock signal experiences less RC delay along the path from the clock driver (40) to p1 than it does along the longer path from the clock driver (40) to p2. This difference in arrival time of the clock signal at p1 and p2 results in clock skew as shown in FIG. 3d. Such clock skew is typically not desirable because components connected to points p1 and p2 will be expecting the arrival of a clock signal at the same time, but in reality, the clock signal will arrive at the components at different times.

### SUMMARY OF INVENTION

According to one aspect of the present invention, an integrated circuit comprises a clock driver disposed on the integrated circuit, a clock grid disposed on the integrated circuit, and at least one interconnect connecting an output of the clock driver to the clock grid at a connection point, where the connection points resides at a non-peripheral region of the clock grid.

According to another aspect, a computer system comprises an integrated circuit having a clock grid, at least one clock driver that provides a clock signal to the clock grid, and a transmission structure operatively connecting an output of the at least one clock driver to at least one point on the clock grid, wherein the at least one point resides at a non-exterior region of the clock grid.

According to another aspect, a method for reducing clock skew comprises sending a clock signal from a clock driver to a first component through a connection point on a clock grid; and sending the clock signal from the clock driver to a second component through the connection point, where the connection point is at a non-peripheral region of the clock grid.

According to another aspect, a transmission structure for driving a signal onto a clock grid comprises an interconnect connecting a clock driver to the clock grid, where the interconnect connects the clock driver to the clock grid at a connection point residing at a non-exterior region of the clock grid.

Other aspects and advantages of the invention will be apparent from the following description and the appended claims.

### BRIEF DESCRIPTION OF DRAWINGS

FIG. 1 shows a typical integrated circuit.

FIG. 2 shows a typical clock distribution network.

FIG. 3a shows a top view of a typical clock distribution network.

FIG. 3b shows a section of the typical clock distribution network shown in FIG. 3a.

FIG. 3c shows an expanded view of the section of the typical clock distribution network shown in FIG. 3b.

FIG. 3d shows a timing diagram in accordance with the expanded view of the section of the typical clock distribution network shown in FIG. 3c.

FIG. 4a shows a section of a clock distribution network in accordance with an embodiment of the present invention.

FIG. 4b shows an expanded view of the section of the clock distribution network shown in FIG. 4a.

FIG. 4c shows a timing diagram in accordance with the expanded view of the section of the clock distribution network shown in FIG. 4b.

FIG. 5 shows a clock distribution network in accordance with another embodiment of the present invention.

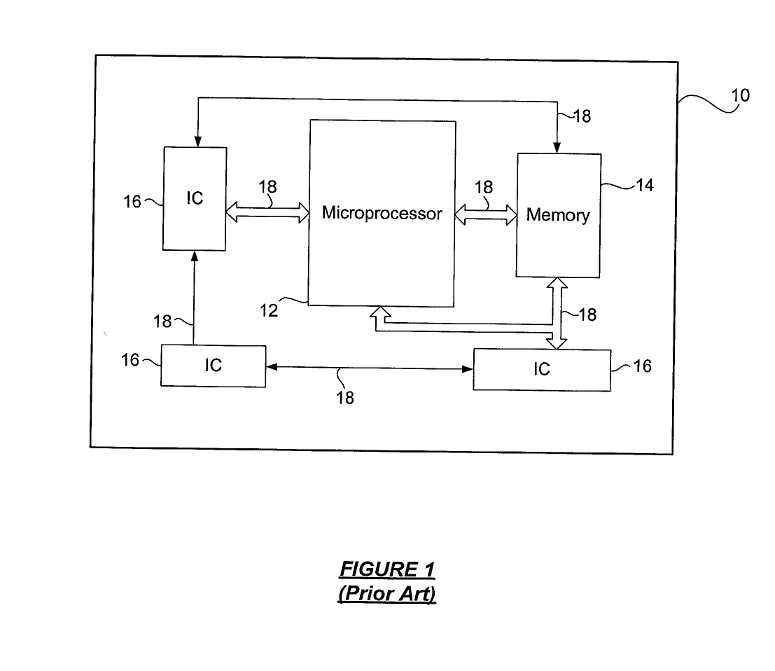

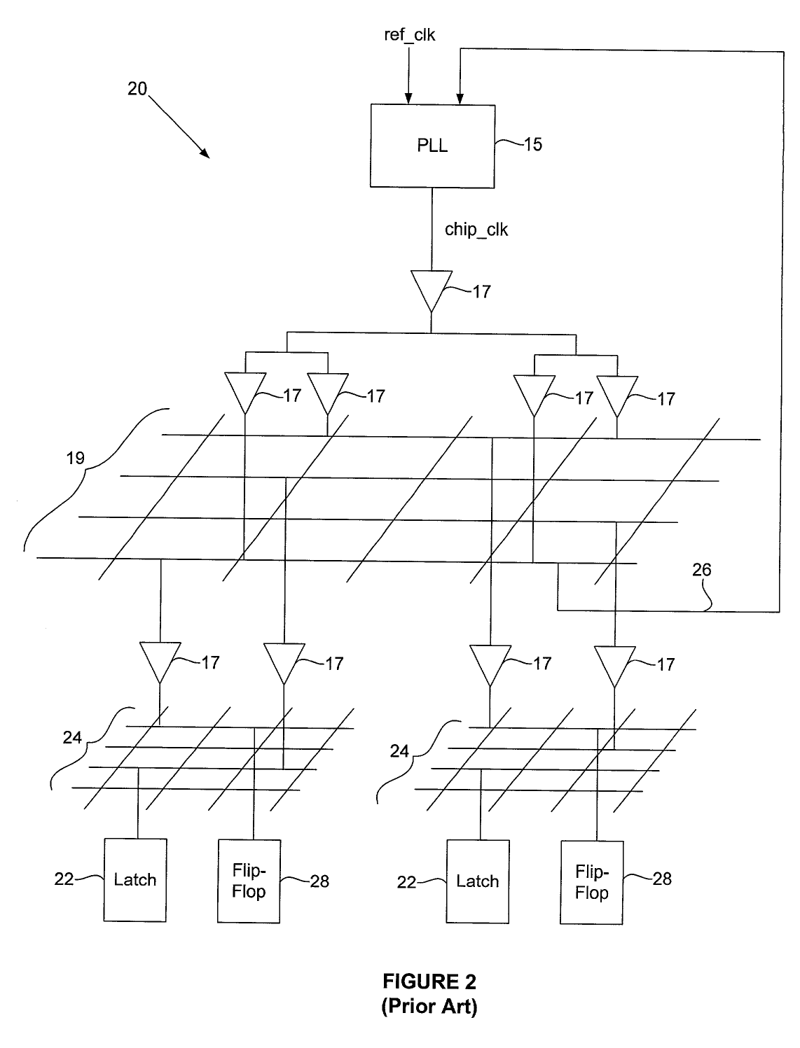

### DETAILED DESCRIPTION

Embodiments of the present invention relate to a clock skew reduction apparatus having a wire tree architecture. Embodiments of the present invention further relate to a method for reducing clock skew using wire tree architecture to connect one or more clock headers to clock grid. Embodiments of the present invention further relate to a clock skew reduction apparatus having a balanced wire tree architecture. Embodiments of the present invention further relate to a method for reducing clock skew using a balanced wire tree structure to connect one or more clock drivers to a clock grid.

A clock skew reduction apparatus and method consistent with the principles of the present invention reduces clock skew on a clock grid of an integrated circuit. The clock skew reduction apparatus and method uses a novel interconnect structure to decrease clock skew among components connected to the clock grid.

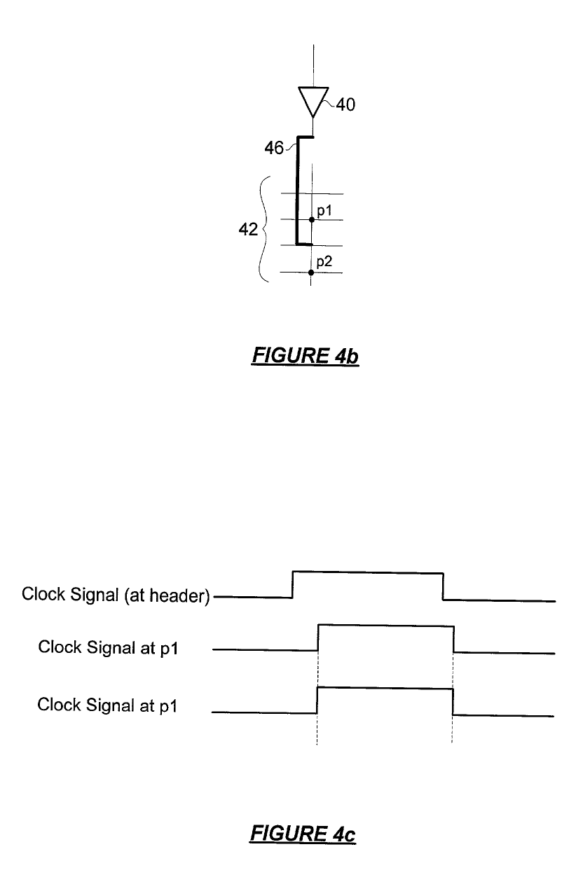

FIG. 4a shows an exemplary section of a clock distribution network in accordance with an embodiment of the present invention. In FIG. 4a, one or more clock drivers (40) are connected to a clock grid (42) via interconnects (46), where the interconnects (46) connect the clock drivers (40) to non-exterior regions of the clock grid (42). The implementation of the interconnects (46) as such allows for a more distributed clock signal on the clock grid (42) relative to prior art structures that distributed a clock signal along the sides, i.e., periphery, of a clock grid. By positioning the interconnects (46) as shown in FIG. 4a, a clock signal may be provided to a component connected to the clock grid (42) more quickly and with less clock skew than in those cases where a clock signal has to propagate from an edge of a clock grid to a particular component.

FIG. 4b shows an expanded view of the section of the clock distribution network shown in FIG. 4a. As discussed above with reference to FIG. 4a, the clock drivers (40) are connected to nodes of the clock grid (42) via interconnects (46) connected to non-exterior regions of the clock grid (42). Two points, p1 and p2, are denoted on the clock grid (42) to represent points on the clock grid (42) where the time of arrival of a clock signal is at interest. Referring now also to the timing diagram shown in FIG. 4c, when a clock signal from a particular clock driver (40) is driven to the clock grid (42), the clock signal arrives at p1 at the same time it arrives at p2. This is due to the fact that the clock signal experiences the same RC delay along the path from the clock driver (40) to p1 as it does along the path from the clock driver (40) to p2. In other words, the distance from the clock driver (40) to p1 is virtually the same as the distance from the clock driver (40) to p2.

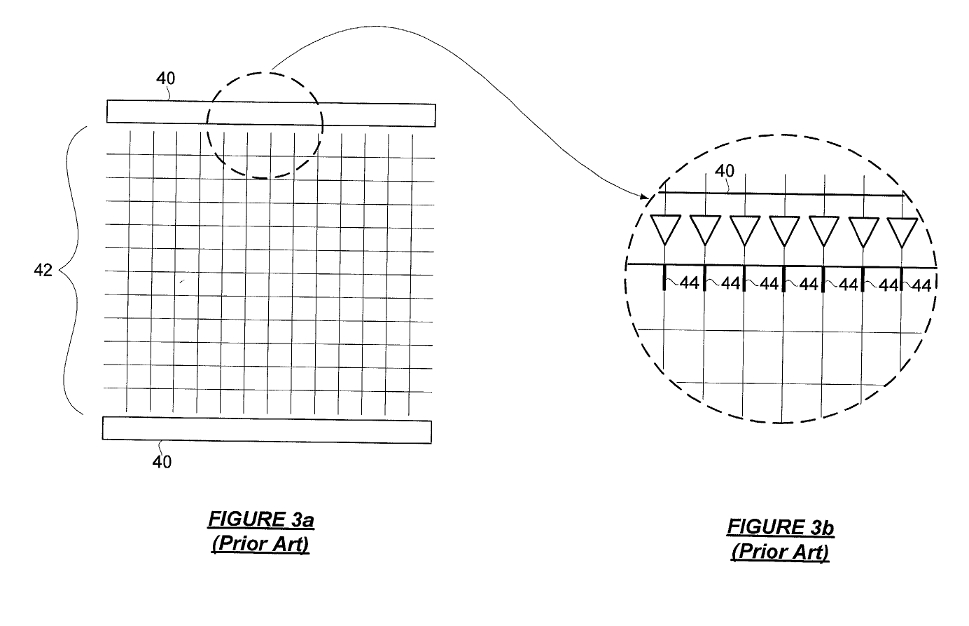

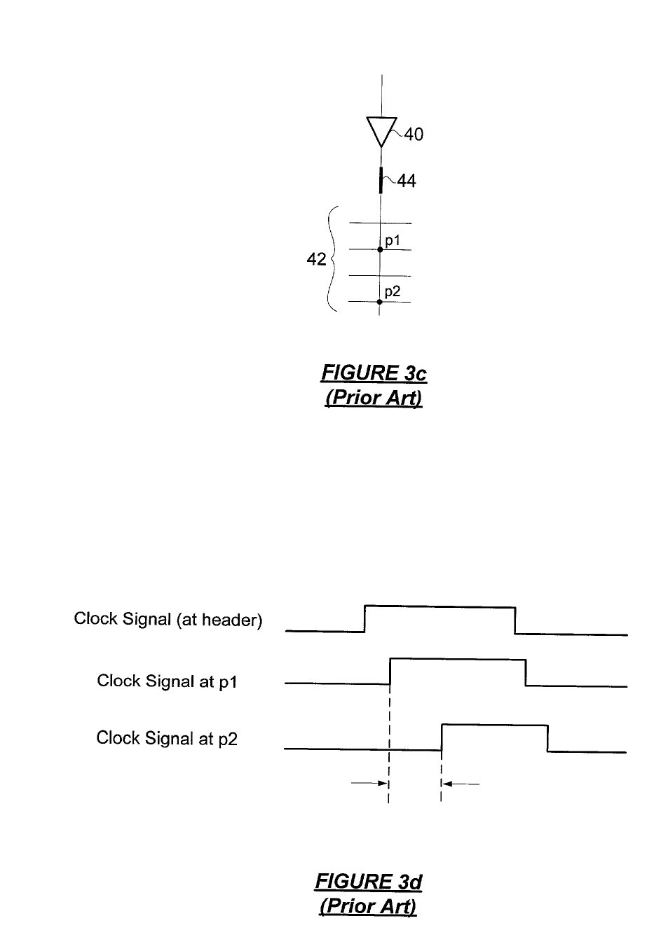

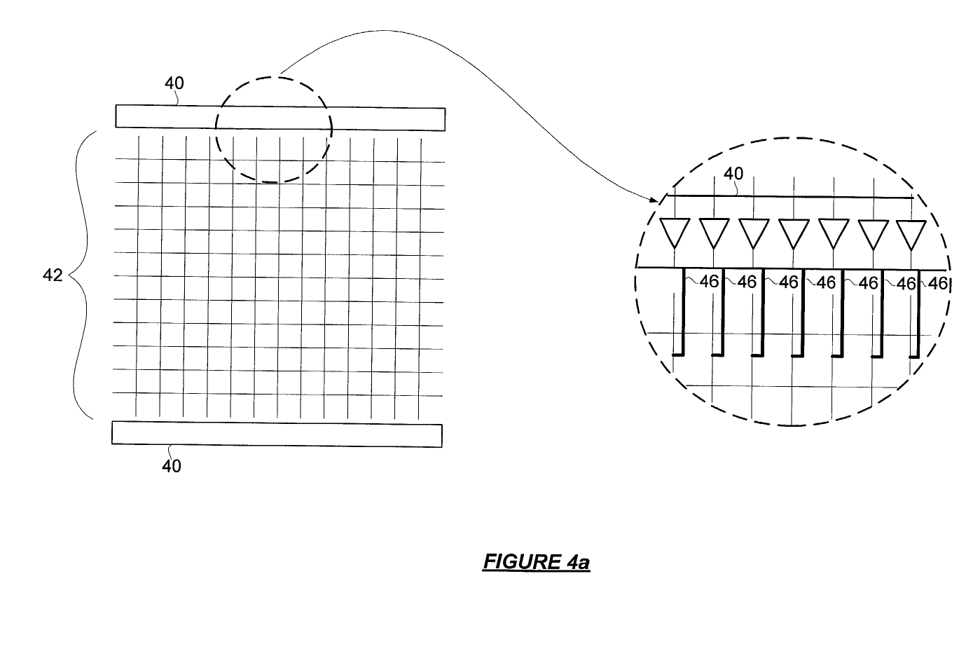

Thus, clock skew among components connected to points p1 and p2 is less than in those cases where clock driver/clock grid interconnect connectivity as shown in FIG. 4a is not used. Further, although zero clock skew is achieved as shown in FIG. 4c, other implementations of the interconnect wire tree architecture may not yield zero clock skew due to p1 and p2 being at slightly different distances from a point on the clock grid (42) at which an interconnect (46) is connected. However, those skilled in the art will appreciate that embodiments of the present invention yield reduced clock skew with respect to prior art implementations as shown in FIGS. 3a-3c. In other words, reduced clock skew is achieved by propagating a clock signal from a clock driver to a clock grid via a non-exterior region of the clock grid rather than propagating the clock signal to the clock grid via an exterior region of the clock grid. Those skilled in the art will further note that RC delay is a function of distance, and thus, by decreasing the distance a signal has to travel, RC delay is reduced accordingly.

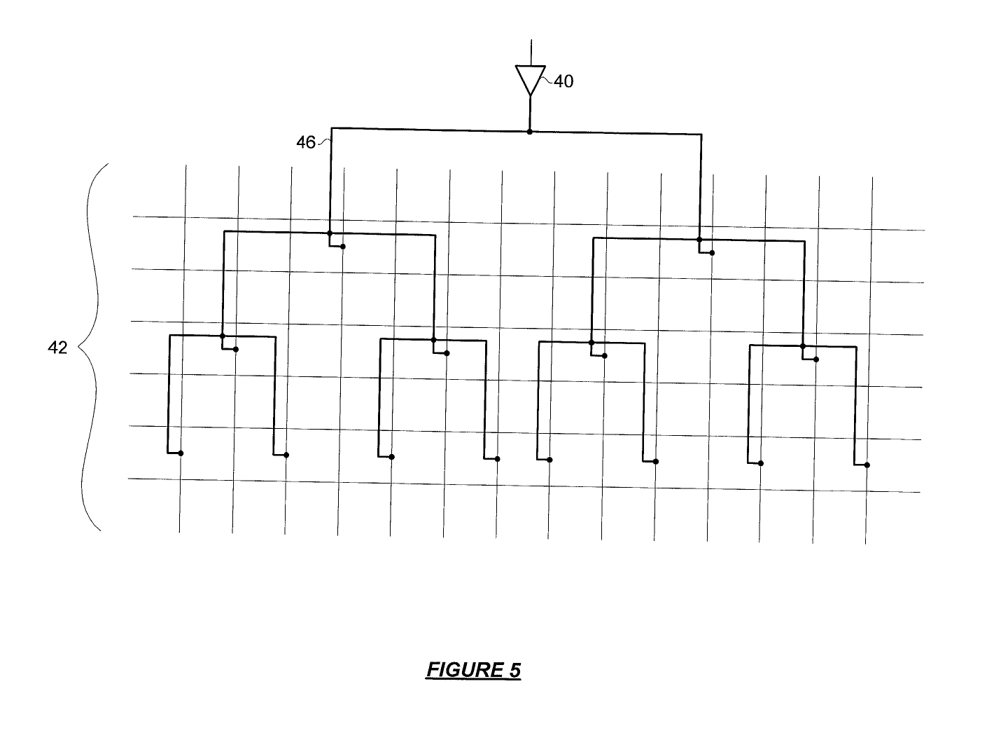

FIG. 5 shows an exemplary clock distribution network in accordance with another embodiment of the present invention. In FIG. 5, a clock driver (40) is connected to a clock grid (42) via interconnects (46) arranged in a balanced wire tree structure. In this particular implementation, because there are a larger amount of connections from the clock driver (40) to the clock grid (42), the uniformity of clock arrival time is improved. Further, in variations of this embodiment, the distance a clock signal has to travel to reach a particular component operatively connected to the clock grid (42) may be less than the distance required if (1) there were a lesser amount of connection points between the clock driver (40) and clock grid (42) and (2) if the connection points were at an exterior region of the clock grid. This results in a decrease in signal delay to components along the clock grid (42), effectively leading to faster performance with less skew. Those skilled in the art will appreciate that the number of connection points may be varied according to the amount of time delay a component can tolerate with respect to an arrival of a clock signal.

Those skilled in the art will appreciate that although the wire tree structure shown in FIGS. 5 is referred to as “balanced,” other embodiments of the present invention may use wire tree structures that are not per se balanced. As long as the wire tree structure connects a clock grid to a clock driver, where the connection points are not solely at a peripheral region of the clock grid, the principles of the present invention are met. Further, the use of a balanced wire tree structure in the drawings is presented for purposes of more easily understanding the present invention. Moreover, wire tree structures are also referred to as “transmission structures.” A transmission structure consistent with the principles of the present invention may be implemented by first designating clock drivers to particular points on a clock grid. Thereafter, a wire tree, using some conductive material, is interlaced within an integrated circuit to form the transmission structure.

Advantages of the present invention may include one or more of the following. In some embodiments, because an interconnect connects a clock driver to a non-exterior, i.e., non-peripheral, region of a clock grid, signal paths from the clock driver may be connected on the clock grid so as to allow a reduction in clock skew among components operatively connected to the clock grid.

In some embodiments, because an interconnect connects a clock driver to a non-exterior, i.e., non-peripheral, region of a clock grid, a signal from the clock driver to a particular point on the clock grid experiences less RC delay than in the case where the clock driver is connected to a peripheral region of the clock grid.

In some embodiments, because a wire tree structure is used with a clock grid, the wire tree structure may be scalable for use with small and large integrated circuits. Further, the simplicity of the balanced wire tree configuration allows for easy integration of this technique in the integrated circuit design and manufacturing processes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An integrated circuit, comprising:
a clock driver disposed on the integrated circuit;
a clock grid disposed on the integrated circuit; and
at least one interconnect connecting an output of the clock driver to the clock grid at a connection point, wherein the connection points resides at a non-peripheral region of the clock grid.

2. The integrated circuit of claim 1, wherein the connection point is positioned such that a component operatively connected to the clock grid at the connection point receives a signal from the clock driver at the connection point, where the signal at the connection point has less skew than if the connection point was positioned at a peripheral region of the clock grid.

3. The integrated circuit of claim 1, wherein the at least one interconnect is arranged in a wire tree configuration.

4. The integrated circuit of claim 3, wherein the wire tree configuration is balanced.

5. A computer system, comprising:
an integrated circuit having a clock grid;
at least one clock driver that provides a clock signal to the clock grid; and
a transmission structure operatively connecting an output of the at least one clock driver to at least one point on the clock grid, wherein the at least one point resides at a non-exterior region of the clock grid.

6. The computer system of claim 5, wherein the at least one point is positioned such that a component operatively connected to the clock grid at the at least one point receives a signal from the clock driver at the at least one point, where the signal at the at least one point has less skew than if the at least one point was positioned at an exterior region of the clock grid.

7. The computer system of claim 5, wherein the transmission structure has a wire tree configuration.

8. The computer system of claim 7, wherein the wire tree configuration is balanced.

9. A method for reducing clock skew, comprising:
sending a clock signal from a clock driver to a first component through a connection point on a clock grid; and
sending the clock signal from the clock driver to a second component through the connection point,
wherein the connection point is at a non-peripheral region of the clock grid.

10. The method of claim 9, wherein the clock signal received by the first component and the second component has less skew than if the connection point was at a peripheral region of the clock grid.

11. The method of claim 9, wherein sending the clock signal from the clock driver to the first component and the second component occurs through a transmission structure, wherein the transmission structure comprises interconnect that connect the clock driver to the connection point on the clock grid.

12. The method of claim 11, wherein the transmission structure is balanced.

13. A transmission structure for driving a signal onto a clock grid, comprising:
an interconnect connecting a clock driver to the clock grid,
wherein the interconnect connects the clock driver to the clock grid at a connection point residing at a non-exterior region of the clock grid.

14. The transmission structure of claim 13, wherein the transmission structure is balanced.
